(19) United States
(12) Patent Application Publication
(10) Pub. No.: US 2015/0221283 A1
(43) Pub. Date: Aug. 6, 2015

(54) DISPLAY DEVICE

(71) Applicant: BOE TECHNOLOGY GROUP CO., LTD., Beijing (CN)

(72) Inventors: Qian Jia, Beijing (CN); Xin Gu, Beijing (CN)

(21) Appl. No.: 14/357,422

(22) PCT Filed: Nov. 22, 2013
(86) PCT No.: PCT/CN2013/087685

§ 371 Date: May 9, 2014

(30) Foreign Application Priority Data
May 31, 2013 (CN) 201310215149.7

(51) Int. Cl. G09G 5/10; G09G 3/32

(52) U.S. Cl. CPC G09G 5/10; G09G 3/3266; G09G 2360/144

(57) ABSTRACT

A display device includes a display panel and an electrochromic panel. The electrochromic panel is provided on the display panel. The electrochromic panel includes an electrochromic unit. The electrochromic unit entirely covers a display region of the display panel. The electrochromic unit is in a transparent state in which light is transmitted in the case that an illuminance of an ambient light is less than or equal to a predetermined value, and the electrochromic unit is in a colored state in which light is partially absorbed in the case that the illuminance of the ambient light is larger than the predetermined value.

### TECHNICAL FIELD

Embodiments of the disclosure relate to a display device.

### BACKGROUND

At present, display devices are generally classified into two categories: liquid crystal display devices and organic light-emitting diode (OLED) display devices, which are widely used in multimedia products such as a mobile phone, a tablet computer, a digital camera and the like. These multimedia products are often used outdoors due to their portability.

When the product with the display device is used outdoors, sunlight reflects on the surface of the display device. In this case, it is difficult for the user to clearly see the image displayed on the display device. To improve the outdoor display effect of the display device, a transflective display device and a display device with a polarizer and a quarter-wave plate are provided.

The transflective display device, although possessing good outdoor display effect, is insufficient in indoor display effect because of low brightness and low contrast compared to a transmissive display device. The display device with the polarizer and the quarter-wave plate is insufficient in indoor display effect as well because the polarizer and the quarter-wave plate absorb light of the display device. To improve the indoor display effect of these display devices, the brightness of these display device are necessarily increased, which will shorten the lifetime of the display devices and result in an image sticking.

### SUMMARY

In some embodiments, a display device comprises a display panel and an electrochromic panel. The electrochromic panel is provided on the display panel. The electrochromic panel comprises an electrochromic unit. The electrochromic unit entirely covers a display region of the display panel. The electrochromic unit is in a transparent state in which light is transmitted in the case that an illuminance of an ambient light is less than or equal to a predetermined value, and the electrochromic unit is in a colored state in which light is partially absorbed in the case that the illuminance of the ambient light is larger than the predetermined value.

In some embodiments, the display device further comprises an illuminance detection unit and a voltage control unit. The illuminance detection unit detects the illuminance of the ambient light, converts the detected illuminance of the ambient light into a signal and transmits the signal to the voltage control unit. The voltage control unit adjusts a drive voltage applied on the electrochromic unit according to the signal transmitted from the illuminance detection unit, so as to control whether the electrochromic unit is in the transparent state in which light is transmitted or in the colored state in which light is partially absorbed.

In some embodiments, the electrochromic unit comprises a first transparent conductive layer, an electrochromic layer, an ion conductive layer, an ion storage layer and a second transparent conductive layer.

In some embodiments, the electrochromic unit comprises a first electrode layer, an electrochromic layer and a second electrode layer.

In some embodiments, the electrochromic unit is in the transparent state in which light is transmitted in the case that the drive voltage applied on the electrochromic unit is a predetermined voltage, whereas the electrochromic unit is in the colored state in which light is partially absorbed in the case that the drive voltage applied on the electrochromic unit is 0. Or, the electrochromic unit is in the colored state in which light is partially absorbed in the case that the drive voltage applied on the electrochromic unit is the predetermined voltage, whereas the electrochromic unit is in the transparent state in which light is transmitted in the case that the drive voltage applied on the electrochromic unit is 0.

In some embodiments, the predetermined voltage is 1-5V.

In some embodiments, the electrochromic layer is made of polythiophene and derivatives thereof, and viologens.

In some embodiments, the predetermined value is 1000 lux-2000 lux.

In some embodiments, the display device further comprises: a touch panel, provided between the display panel and the electrochromic panel.

In some embodiments, the illuminance detection unit and the voltage control unit are integrated into an IC chip on the electrochromic panel.

In some embodiments, the display panel is a liquid crystal panel or an OLED display panel.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a sectional view illustrating a display device according to some embodiments of the disclosure;

FIG. 2 is a sectional view illustrating another display device according to some embodiments of the disclosure;

FIG. 3 is a sectional view illustrating still another display device according to some embodiments of the disclosure;

FIG. 4 is a schematic view illustrating a light path of a display device according to some embodiments of the disclosure in the case that an illuminance of an ambient light is relatively high; and

FIG. 5 is a schematic view illustrating a light path of a display device according to some embodiments of the disclosure in the case that the illuminance of the ambient light is relatively low.

### DESCRIPTION OF THE EMBODIMENTS

In order to make objects, technical details and advantages of the embodiments of the disclosure apparent, the technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

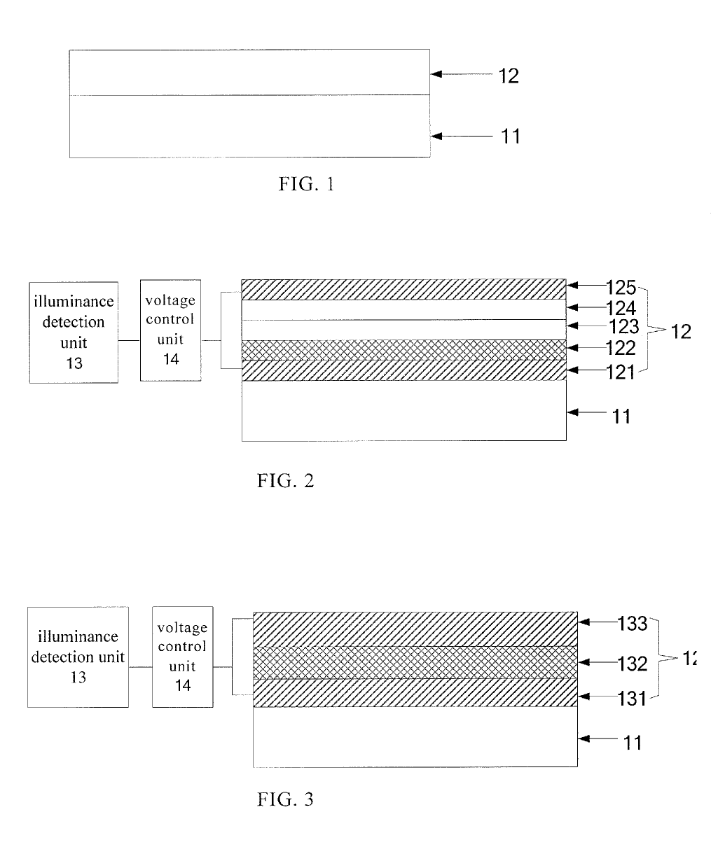

According to some embodiments of the disclosure, a display device is provided. As shown in FIG. 1, the display device comprises a display module and an electrochromic panel. For example, the display module is a display panel 11, and the electrochromic panel comprises an electrochromic unit 12. The electrochromic unit 12 entirely covers a display region of the display panel 11. The electrochromic unit 12 is in a transparent state in which light is transmitted in the case that an illuminance of an ambient light is less than or equal to a predetermined value, and the electrochromic unit 12 is in a colored state in which light is partially absorbed in the case that the illuminance of the ambient light is larger than the predetermined value.

For example, the display panel 11 is a liquid crystal display panel or an OLED display panel; however, the embodiments are not limited thereto.

In the display device according to some embodiments, the electrochromic panel comprising the electrochromic unit is provided on the display panel. In the case that the surrounding environment is too bright (e.g., outdoors), the electrochromic unit is in the colored state in which light is partially absorbed, so that the ambient light is partially absorbed by the electrochromic unit and the transmittance of the ambient light is reduced. In this way, less ambient light is reflected on a surface of the display device, and thus the outdoor display effect of the display device is improved. In addition, in the case that the surrounding environment is not bright enough (e.g., indoors), the electrochromic unit is in the transparent state in which light is transmitted, so that the indoor display effect of the display device can be guaranteed.

It should be noted that, the indoor or outdoor environment mentioned in the embodiments of the disclosure is just exemplary surrounding environment. The state of the electrochromic unit is determined depending on the illuminance of the ambient light. The electrochromic unit is in the transparent state in which light is transmitted in case that the illuminance of the ambient light is less than or equal to the predetermined value; the electrochromic unit is in the colored state in which light is partially absorbed in the case that the illuminance of the ambient light is larger than the predetermined value. For example, the predetermined value is 1000 lux-2000 lux. For example, the predetermined value is 1500 lux, the electrochromic unit 12 is in the transparent state in which light is transmitted in the case that the illuminance of the ambient light is less than or equal to 1500 lux, and the electrochromic unit 12 is in the colored state in which light is partially absorbed in the case that the illuminance of the ambient light is larger than 1500 lux.

In some embodiments, as shown in FIG. 2, the display device further comprises an illuminance detection unit 13 and a voltage control unit 14. The illuminance detection unit 13 detects the illuminance of the ambient light, converts the detected illuminance of the ambient light into a signal and transmits the signal to the voltage control unit 14. The voltage control unit 14 adjusts a drive voltage applied on the electrochromic unit 12 according to the signal transmitted from the illuminance detection unit 13, so as to control whether the electrochromic unit 12 is in the transparent state in which light is transmitted or in the colored state in which light is partially absorbed.

In some embodiments, as shown in FIG. 2, the electrochromic unit 12 comprises a first transparent conductive layer 121, an electrochromic layer 122, an ion conductive layer 123, an ion storage layer 124 and a second transparent conductive layer 125. In some embodiments, as shown in FIG. 3, the electrochromic unit comprises a first electrode layer 131, an electrochromic layer 132 and a second electrode layer 133.

In some embodiments, the illuminance detection unit 13 comprises a photosensitive component such as a photosensitive resistor. The photosensitive resistor converts the illuminance of the ambient light into an electric signal. The illuminance detection unit 13 transmits the electric signal to the voltage control unit 14. The voltage control unit 14 adjusts the drive voltage applied on the electrochromic unit 12 according to the received electric signal. The electric signal corresponds to the illuminance of the ambient light; therefore the voltage control unit 14 adjusting the drive voltage applied on the electrochromic unit 12 according to the electric signal means that the voltage control unit 14 adjusts the drive voltage applied on the electrochromic unit 12 according to the illuminance of the ambient light. In the electrochromic unit 12 as shown in FIG. 2, the voltage control unit 14 applies the drive voltage on the first transparent conductive layer and the second transparent conductive layer. In the electrochromic unit as shown in FIG. 3, the voltage control unit 14 applies the drive voltage on the first electrode layer and the second electrode layer. The drive voltage applied on the electrochromic unit 12 determines whether the electrochromic layer is in the transparent state or in the colored state.

In some embodiments, the electrochromic layer is made of polythiophene and derivatives thereof, viologens and the like. The materials for forming the electrochromic layer are divided into two types: a first type and a second type. When the materials of the first type are used to form the electrochromic layer, the electrochromic unit is in the transparent state in which light is transmitted in the case that the drive voltage applied on the electrochromic unit is a predetermined voltage, whereas the electrochromic unit is in the colored state in which light is partially absorbed in the case that the drive voltage applied on the electrochromic unit is 0. When the materials of the second type are used to form the electrochromic layer, the electrochromic unit is in the colored state in which light is partially absorbed in the case that the drive voltage applied on the electrochromic unit is the predetermined voltage, whereas the electrochromic unit is in the transparent state in which light is transmitted in the case that the drive voltage applied on the electrochromic unit is 0. Therefore, methods adopted by the voltage control unit to adjust the drive voltage applied on the electrochromic unit are different for materials for forming the electrochromic layer are different.

For example, when the materials of the first type are used to form the electrochromic layer, the voltage control unit applies the predetermined voltage on the electrochromic unit in the case that the illuminance of the ambient light is relatively low so that the electrochromic unit is in the transparent state in which light is transmitted, whereas the voltage control unit does not apply any voltage on the electrochromic unit in the case that the illuminance of the ambient light is relatively high so that the electrochromic unit is in the colored state in which light is partially absorbed.

For example, when the materials of the second type are used to form the electrochromic layer, the voltage control unit does not apply any voltage on the electrochromic unit in the case that the illuminance of the ambient light is relatively low so that the electrochromic unit is in the transparent state in which light is transmitted, whereas the voltage control unit applies the predetermined voltage on the electrochromic unit in the case that the illuminance of the ambient light is relatively high so that the electrochromic unit is in the colored state in which light is partially absorbed.

For example, the predetermined voltage is 1-5V.

In some embodiments, the display device further comprises a touch panel; the touch panel is provided between the display panel and the electrochromic unit and is used for achieving a touch operation.

In some embodiments of the disclosure, the illuminance detection unit 13 and the voltage control unit 14 are integrated in an integrated circuit (IC) chip on the electrochromic panel. For example, the IC chip of the electrochromic panel is separated from an IC chip of the display panel.

In some embodiments, a manufacturing method of the electrochromic unit as shown in FIG. 3 is provided. For example, the method comprises the following steps.

S1: respectively forming a transparent conductive thin film on two transparent substrates to obtain two substrates. For example, the transparent conductive thin film is made of an inorganic conductive material such as ITO or an organic conductive material such as polyethylene dioxythiophene (PEDOT). For example, the transparent substrate is a glass substrate.

S2: forming an electrochromic layer on one of the two substrates by a deposition method. For example, the deposition method is an electrochemical deposition method. For example, an electrolyte is dropped onto the electrochromic layer to form an electrolyte layer, and the electrolyte layer is used as an ion transmission passage.

S3: bonding the substrate on which the electrochromic layer is formed with the other substrate, and thinning the two transparent substrates. Thus, the electrochromic unit as shown in FIG. 3 is obtained, the two substrates provided with the transparent conductive thin films are used as the first electrode layer 131 and the second electrode layer 133, and the electrochromic layer 132 is provided between the first electrode layer 131 and the second electrode layer 133.

In some embodiments, the manufacturing method of the electrochromic unit as shown in FIG. 3 comprises the following steps.

Q1: respectively adhering a plastic thin film onto two transparent substrates and forming a transparent conductive thin film on the plastic thin film to form two substrates. For example, the transparent conductive thin film is made of an inorganic conductive material such as ITO or an organic conductive material such as PEDOT. For example, the transparent substrate is a glass substrate.

Q2: forming an electrochromic layer on one of the two substrates by a deposition method. For example, the deposition method is an electrochemical deposition method. For example, an electrolyte is dropped onto the electrochromic layer to form an electrolyte layer, and the electrolyte layer is used as an ion transmission passage.

Q3: bonding the substrate on which the electrochromic layer is formed with the other substrate, and separating the glass substrate from the plastic thin film. Thus, the electrochromic unit as shown in FIG. 3 is obtained, the two plastic thin films provided with the transparent conductive thin films are used as the first electrode layer 131 and the second electrode layer 133, and the electrochromic layer 132 is provided between the first electrode layer 131 and the second electrode layer 133

After the electrochromic unit is manufacture by using the methods mentioned above, the IC chip integrated with the illuminance detection unit and the voltage control unit is bonded onto the electrochemical unit to form the electrochemical panel. The electrochemical panel is boned with the display panel by an adhering manner or other suitable manners to form the display device according to the embodiments of the disclosure.

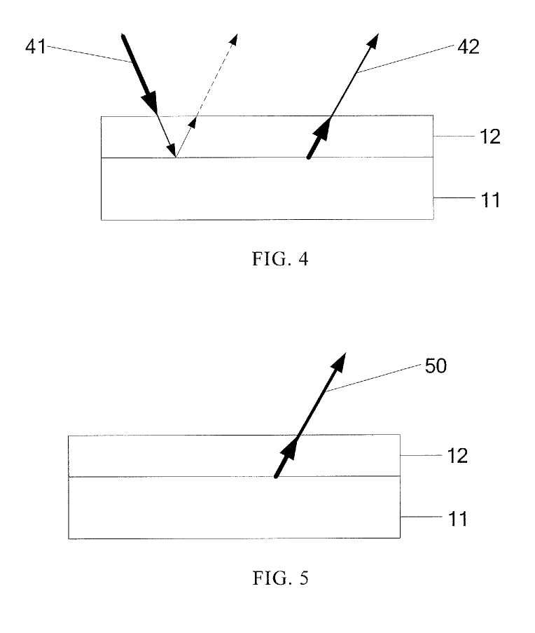

The display device according to the embodiments of the disclosure improves the outdoor display effect while guarantees the indoor display effect. FIG. 4 is a schematic view illustrating a light path of the display device according to some embodiments of the disclosure in the case that the illuminance of the ambient light is relatively high. As shown in FIG. 4, the electrochromic unit is in the colored state in which light is partially absorbed, so that the ambient light 41 is partially absorbed by the electrochromic unit provided on the display panel and the transmittance of the ambient light is reduced. In this way, less ambient light is reflected on the surface of the display device, the reflected ambient light is negligible with respect to the light 42 of the display device, and thus the outdoor display effect of the display device is improved.

FIG. 5 is a schematic view illustrating a light path of the display device according to some embodiments of the disclosure in the case that the illuminance of the ambient light is relatively low. The ambient light is negligible with respect to the light of the display device, the electrochromic unit 12 is in the transparent state and does not absorb the light 50 of the display device, and thus the indoor display effect of the display device is guaranteed.

The display device according to some embodiments of the disclosure are applied to a digital camera, a mobile phone, a tablet computer, an e-paper or any other products or components having a display function.

The foregoing embodiments merely are exemplary embodiments of the disclosure, and not intended to define the scope of the disclosure, and the scope of the disclosure is determined by the appended claims.

1. A display device, comprising:
a display panel; and
an electrochromic panel, provided on the display panel, wherein
the electrochromic panel comprises an electrochromic unit,
the electrochromic unit entirely covers a display region of the display panel, and
the electrochromic unit is in a transparent state in which light is transmitted in the case that an illuminance of an ambient light is less than or equal to a predetermined value, and the electrochromic unit is in a colored state in which light is partially absorbed in the case that the illuminance of the ambient light is larger than the predetermined value.

2. The display device according to claim 1, further comprising an illuminance detection unit and a voltage control unit, wherein
the illuminance detection unit detects the illuminance of the ambient light, the illuminance detection unit converts the detected illuminance of the ambient light into a signal and the illuminance detection unit transmits the signal to the voltage control unit; and
the voltage control unit adjusts a drive voltage applied on the electrochromic unit according to the signal transmitted from the illuminance detection unit, so as to control whether the electrochromic unit is in the transparent state in which light is transmitted or in the colored state in which light is partially absorbed.

3. The display device according to claim 2, wherein the electrochromic unit comprises a first transparent conductive layer, an electrochromic layer, an ion conductive layer, an ion storage layer and a second transparent conductive layer.

4. The display device according to claim 2, wherein the electrochromic unit comprises a first electrode layer, an electrochromic layer and a second electrode layer.

5. The display device according to claim 3, wherein
the electrochromic unit is in the transparent state in which light is transmitted in the case that the drive voltage applied on the electrochromic unit is a predetermined voltage, whereas the electrochromic unit is in the colored state in which light is partially absorbed in the case that the drive voltage applied on the electrochromic unit is 0; or
the electrochromic unit is in the colored state in which light is partially absorbed in the case that the drive voltage applied on the electrochromic unit is the predetermined voltage, whereas the electrochromic unit is in the transparent state in which light is transmitted in the case that the drive voltage applied on the electrochromic unit is 0.

6. The display device according to claim herein the predetermined voltage is 1-5 V.

7. The display device according to claim 5, wherein the electrochromic layer is made of polythiophene and derivatives thereof, and viologens.

8. The display device according to claim 1, wherein the predetermined value is 1000 lux-2000 lux.

9. The display device according to claim 1, further comprising:
a touch panel, provided between the display panel and the electrochromic panel.

10. The display device according to claim 2, wherein the illuminance detection unit and the voltage control unit are integrated into an IC chip on the electrochromic panel.

11. The display device according to claim 1, wherein the display panel is a liquid crystal panel or an OLED display panel.

12. The display device according to claim 4, wherein
the electrochromic unit is in the transparent state in which light is transmitted in the case that the drive voltage applied on the electrochromic unit is a predetermined voltage, whereas the electrochromic unit is in the colored state in which light is partially absorbed in the case that the drive voltage applied on the electrochromic unit is 0; or
the electrochromic unit is in the colored state in which light is partially absorbed in the case that the drive voltage applied on the electrochromic unit is the predetermined voltage, whereas the electrochromic unit is in the transparent state in which light is transmitted in the case that the drive voltage applied on the electrochromic unit is 0.

13. The display device according to claim 12, wherein the predetermined voltage is 1-5 V.
